(19) United States
(12) Patent Application Publication
(10) Pub. No.: US 2004/0018478 A1
(43) Pub. Date: Jan. 29, 2004

(54) System and method for video interaction with a character

(76) Inventor: Thomas L. Styles, Mesa, AZ (US)

Correspondence Address: SNELL & WILMER, ONE ARIZONA CENTER, 400 EAST VAN BUREN, PHOENIX, AZ, 850040001

(21) Appl. No.: 10/202,555

(22) Filed: Jul. 23, 2002

(51) Int. Cl. G09B 3/00

(52) U.S. Cl. 434/350; 434/307 R; 434/365

(57) ABSTRACT

An interactive video system and method is configured to enhance interaction between a user and a video based subject. An exemplary video interaction system and method includes the steps of playing a video clip, presenting a user with response options, receiving a user response selection, and selecting a subject response video clip.

### FIELD OF THE INVENTION

The present invention generally relates to a video interaction system and method. More particularly, the present invention relates to a video interaction system and to methods for facilitating interaction between a user and a filmed video character.

### REFERENCE TO COMPUTER PROGRAM LISTING

A computer program listing appendix is submitted herewith on compact disc (“CD”). The computer program listing is contained in a single file named Code.txt on a single compact disc. The file was created on the CD on Jul. 17, 2002 at 7:06 AM and is 17 KB in size. A copy CD is also included herewith for a total of two CD's. The computer program listing appendix, as recorded on the compact disk, is incorporated herein by reference.

### BACKGROUND OF THE INVENTION

In the entertainment and education industries, interactive video games have been very successful. In general, user interaction with a character holds the user's attention longer and increases the entertainment value of the game. However, interactive video games continue to lack realism in the look and feel of the character and the interaction.

For example, objects presented in video games, including any human characters, are usually constructed using geometric primitives and mathematical methods. The subjects in these presentations are not typically filmed using live subjects or real objects. Computer generated characters are typically less natural and less appealing in appearance and movement than actual characters that have been filmed using live subjects or real objects. Thus, even with improvements in animation, the characters and other objects do not look life-like and this stands in the way of a user's suspension of disbelief during the “game”.

Furthermore, video characters appear to be less than real because the characters have no personality, or only a simple personality which cannot be configured or directly modified by the user. Also, video characters generally respond deterministically. That is, if the user opens the application and takes exactly the same actions as the last time the application was played, the character exhibits exactly the same behavior. In sum, present day interactive video poorly represents the behavior of human characters, actors, and/or the like.

In addition, today's interactive media does not address the human need for interaction solely for the sake of interaction. For example, phone conferences and in person discussions can be therapeutic, healthy, and uplifting as an individual expresses themselves and receives feedback to their comments. Instead, interactive video tends to be of the video game type in which a user tries to optimize a score or pursue a defined objective. Moreover, in many games, the user plays the role of a character that appears on screen and interacts with one or more other characters or objects on the screen. The user does not typically interact with the video game from the perspective of himself or herself as a real person external to the video display device. Thus, a need exists for an interactive video system and method for facilitating enhanced interaction between a user and a video character.

### BRIEF SUMMARY OF EXEMPLARY EMBODIMENTS OF THE INVENTION

In accordance with various aspects of the present invention, an interactive video system and method is configured to enhance interaction between a user and a video based subject. An exemplary video interaction system and method includes the steps of playing a video clip, presenting a user with at least one response option for interacting with the subject, receiving a user response selection representing one of said at least one option, and selecting one of a plurality of pre-recorded video clips of the subject based at least in part on the user selection. The subject response video clips include a filmed subject.

### BRIEF SUMMARY OF THE DRAWING FIGURES

A more complete understanding of the various aspects of the present invention may be derived by referring to the detailed description and claims when considered in connection with the Figures, where like reference numbers refer to similar elements throughout the Figures, and:

FIG. 1 illustrates an exemplary video interaction system in accordance with an exemplary embodiment of the present invention;

FIGS. 2-3 illustrate exemplary video interaction methods in accordance with exemplary embodiments of the present invention;

FIG. 4 illustrates an exemplary character response selection method in accordance with exemplary embodiments of the present invention;

FIG. 5 illustrates an exemplary character-user interaction sequence in accordance with exemplary embodiments of the present invention; and

FIGS. 6-8 illustrate exemplary state and activity diagrams in accordance with exemplary embodiments of the present invention.

### DETAILED DESCRIPTION OF EXEMPLARY EMBODIMENTS OF THE INVENTION

Interaction between a user and a filmed subject is a highly desirable mode of entertainment. In accordance with various aspects of the present invention, interaction between a user and a filmed subject is facilitated by systems and methods for using filmed subjects in pre-recorded video clips. An exemplary interaction method includes the steps of playing a video clip, presenting a user with response options, receiving a user response selection, and selecting a subject response to the video clip. Various exemplary steps in the interaction method further enhance the user-subject interaction by selecting subject responses to user inputs in a non-deterministic manner based on, for example, probability distributions, a subject's personality, the history of the interaction and/or other factors.

### Video Clips:

In accordance with an exemplary embodiment of the present invention, video clips are selected for presentation to a user in response to user inputs. The video clips include a filmed subject, as opposed to computer animation. Prior art computer animated subjects are generally constructed using geometric primitives and mathematical methods. In contrast, a filmed subject is a physical, tangible object that has been transformed from a three dimensional real world subject to a two dimensional digital visual representation of that object. Thus the filmed subject suitably looks lifelike and enhances the user's perception of the image. The subject may be filmed with either digital or analog technology using any suitable digital or analog recording technique to create the video clips. Any conventional recording technique can be used. The video clips may or may not be further edited or manipulated. The resulting video clip is a segment of action and/or words to which a user may respond. The segment may be of relatively short duration, perhaps on the order of I to 5 seconds, although any duration could be used. The video clips may be stored as digital files in video formats or file types such as Motion Picture Experts Group (“MPEG”), MPEG 1, MPEG2, MPEG4, Audio-Video Interleaved (“AVI”), QuickTime, and/or the like.

### A Filmed Subject:

To simplify the description of the exemplary embodiments, the invention is frequently described herein as pertaining to a system for facilitating interaction between a user and a filmed actor for entertainment purposes. However, interactive video systems and methods, such as those described herein, may be used by many other applications. For example, interactive video methods may be used in any educational interactive video environment, including teaching foreign languages, phonetics, math, and/or the like.

Furthermore, a user may interact with characters or subjects other than actors, such as cartoon or animated characters, movie characters, and/or the like. Thus, a subject may be any person, human actor, puppet character, object, machine, claymation figure, and/or the like. A filmed subject is any such subject as captured on video clips through a recording process. The recording process may include the editing and manipulation of the film.

Use of a filmed character may be advantageous over animation for a variety of reasons, such as reducing the time and/or expense to create the subject and enhancing the appearance of the character. In one exemplary embodiment of the present invention, a single subject, or a single actor, is present in each video clip. Use of a single subject may enhance the effect of one-to-one interaction between the user and the subject. In other examples, multiple subjects may be presented in a single video clip.

System:

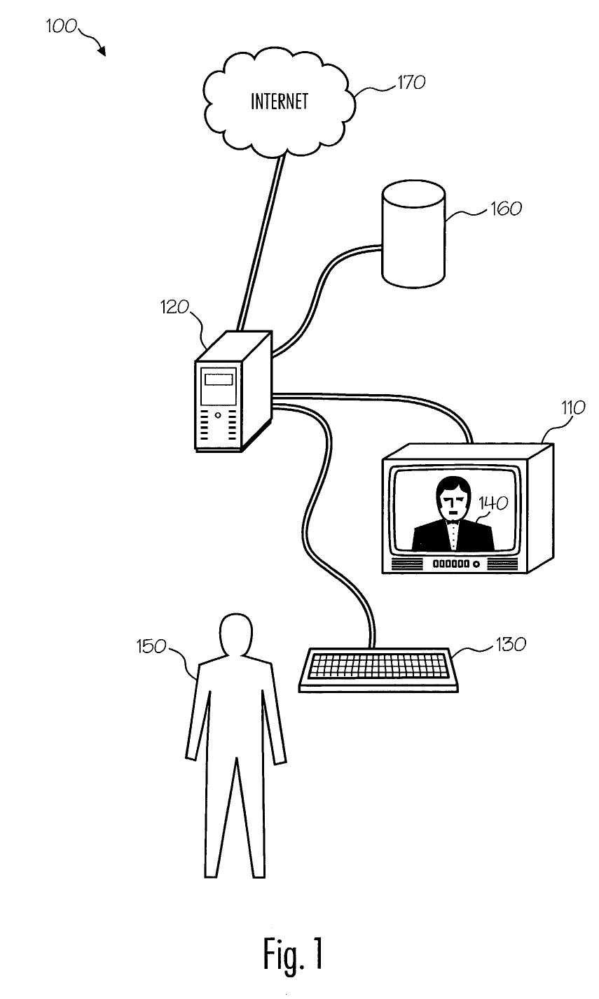

FIG. 1 illustrates an exemplary interactive video system 100 which suitably includes a video display device 110, a processing device 120, and an input device 130. Processing device 120 is suitably configured to communicate with video display device 110 and input device 130.

Display Device:

In this example, a subject 140 is displayed to a user 150 via any suitable display device 110. For example, display device 110 may be a computer monitor, television, personal digital assistant (PDA) screen, laptop screen, projection device, and/or the like. Display device 110 may further include internal and/or remote speakers for presenting accompanying audio portions of the video clips. Display device 110 is configured to receive video and/or audio signals and to present these signals to user 150 as video clips.

Display device 110 may also present possible response options that a user may select to interact with the filmed subject. For example, the video clip may end with a frozen video frame of the character and/or superimposed text presenting options that a user may select. In other response displaying methods, subtitles may be used or the response options may be presented after the video clip has been shown. Other suitable techniques and/or devices for conveying (in either visual or audio format) the response options to the user may also be used. For example, headphones or an audio speaker may provide the response options in audio format or an input device may be configured to additionally display the response options. The response options include one or more available responses, relevant to the video clip that just played.

Input Device:

User 150 may interact with subject 140 by observing the video clips of subject 140 performed on display device 110 and selecting a suitable response option using input device 130. In this example, input device 130 is a computer keyboard; however, other suitable input devices may be used. For example, input device 130 may include a mouse, pointer, remote control, and/or the like. Furthermore, voice recognition technology may be used in conjunction with an input device 130 to capture the user's voice responses and further enhance the interactive experience. Other suitable input devices may also be used for receiving a user's selection of a response option.

Processor:

The user input is received and processed by a processor 120 which determines an appropriate video clip for display as a subject's response to the user's input. Processor 120 may be any hardware, such as any microprocessor or controller, with associated memory, input/output, and/or software. In addition to being connected to input device 130 and display device 110, processor 120 may further be connected to local or remote storage device 160 and/or other processors via internet 170. Thus, video clips may be stored locally or remotely. Local storage may, for example, include DVD-R, CD-ROM, RAM, ROM, Flash Memory, magnetic or optical storage and/or the like. The video clips may also be streamed over the Internet or another network from similar remote storage.

User:

System 100 may be configured such that a user interacts with a filmed subject from the perspective of an individual external to the display device/video clip. In this example, the interaction simulates a two way video conference. In another example, an animated character on the screen may represent the user. The animated character would then speak or act in accordance with the user responses selected by the user. Thus, the user may experience the illusion of being the animated character interacting with the filmed subject. In yet another example, a second video subject may appear on the display device with the first filmed subject or may appear interchangeably with the first filmed subject, where the second video subject represents the user. As with the animated character example, the user may experience the illusion of being one of the two filmed subjects and interact with the other filmed subject.

Method:

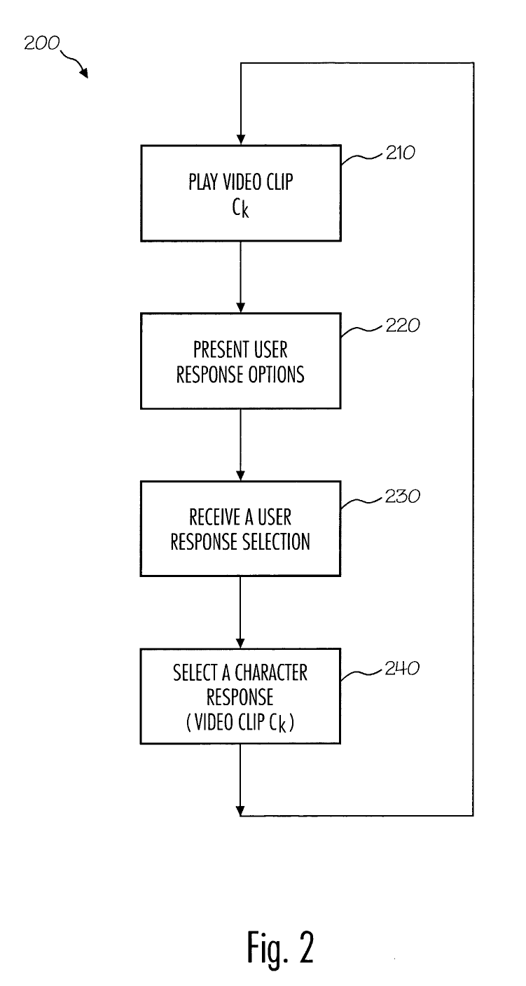

With reference now to FIG. 2, an exemplary video interaction method 200 includes the steps of playing a video clip 210, presenting a user with response options 220, receiving a user response selection 230, and selecting a subject response (responding video clip) 240. The method may repeat multiple times, playing one or more (generally just one) video clips with each cycle. A video clip is played, in step 210, for user 150 on device 110. The playing of a video clip is accomplished by including media playing steps in the method. The media playing steps may include calling library routines, i.e., subroutines, from packages such as Microsoft DirectShow or Java Media Framework or other such packages. Alternatively, media playing steps may be coded completely within the application itself.

In step 220, user 150 may then be shown several possible responses to the video clip just seen by the user. In step 230, the user responds to the video clip by selecting one of the available response options. The selection may be made by keyboard, mouse, voice or other device. The subject's response to the user's selection is then determined in step 240 using methods described in further detail herein.

Initiation:

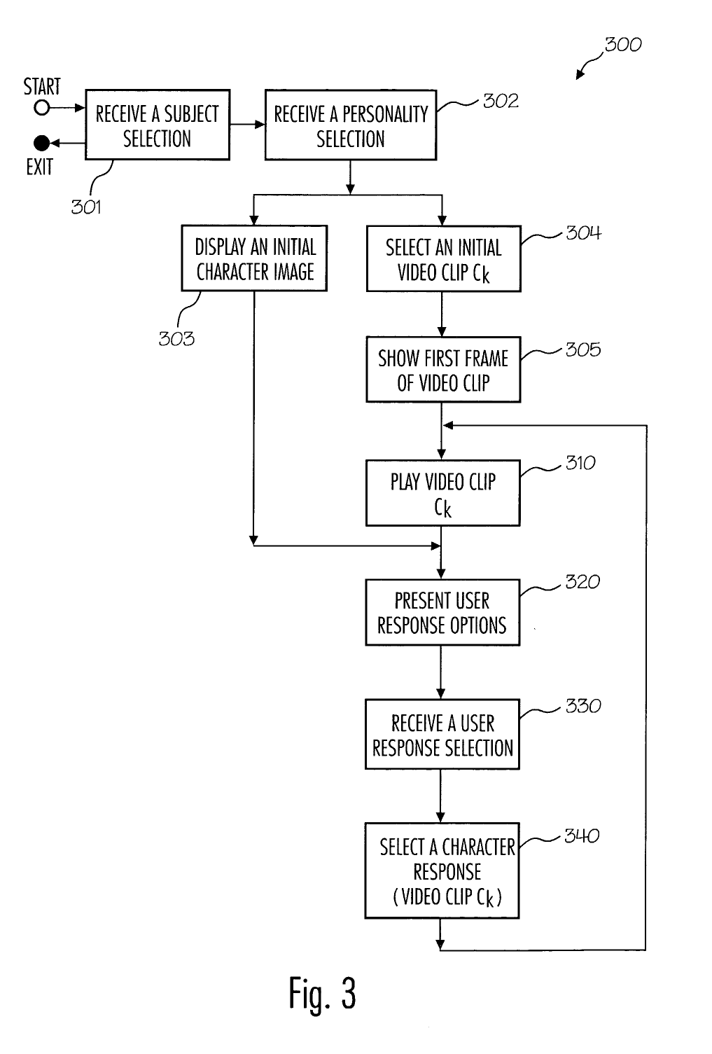

Various initial actions may be taken before entering the interaction method 200, and interaction method 200 may be entered at or between various steps of the method. For example, FIG. 3 illustrates an exemplary video interaction loop with various exemplary introduction steps (301-309). In one exemplary embodiment, a user starts a session by selecting from among various subjects with whom the user desires to interact. For example, the user may select from an alphabetical listing of actors or actresses. In a step 301, the processor receives the user's subject selection. In other video interaction methods, a single subject is provided for interaction, thereby eliminating the need for selecting a subject. In such methods, the user selection is made by merely initiating a session dedicated to that particular character/subject.

Assigning one or More Personality Traits to a Character:

In a step 302, a subject personality selection may be received from the user. The personality selection may be in response to one or more personality factors offered to the user. The personality factors may focus on the subject's friendliness, aggressiveness, intelligence, risk taking, and/or the like. Furthermore, personality factors may include other subject characteristics such as gender, and social/economic factors. The user may select such personality traits in a binary fashion, such as the presence or non-existence of a temper, or patience. In another example, the user may specify the subject's personality over a range; such as an average, below average, or above average capacity for a particular personality trait. Furthermore, the subject's capacity for a particular trait may be measured by percentage, using a sliding scale, and/or the like. The subject's personality may be pre-set at default personality levels and these default personality levels can then be modified by the user. These ranges may be selected from two or more personality levels associated with any one trait, by a sliding bar, or other indicator of the strength of such a factor. The processor may receive the user's personality factor selection(s) in a step 302. Alternatively, the personality of the character may be pre-set with no user input step.

In various embodiments, the video interaction loop may be entered at different points. In one exemplary embodiment, the video interaction loop is entered at step 310, where a selected video clip is played. In this example, an initial video clip is selected in a step 304. The initial video clip may be a standard introduction clip for that subject, or may be selected from among many clips using techniques described herein. A first frame of the initial video clip is displayed in a step 305, and the system waits to receive a user input that starts the playing of the video clip. The video clip is then played in step 310 of the interaction loop.

In another example, the video interaction loop is entered at step 320 where the user is presented with response options. In this example, in a step 303, an initial image of the subject is displayed before presenting the user with a number of response options in step 320. Alternatively, other introductory steps may be taken and the video interaction loop may be entered other points while still performing the user/subject video interaction method of the present invention.

Playing a Video Clip:

The video clips may be indexed in any suitable manner facilitating retrieval of a specific video segment. For example, each video clip may be assigned an index number such that Cₖ represents the Kth video clip, where K=1 to n total video clips. In step 310, video clip Cₖ is played to a user via a display device. The video clip to be played is selected in an earlier step, such as step 304 or 340. In accordance with an exemplary embodiment of the present invention, the implementation involves a package or toolset that decodes and presents video clips stored in a compressed format such as MPEG, and/or the like.

Presenting User With Response Option(s):

The user is presented with response options in a step 320. The response options include one or more possible responses to the Kth video clip. The response options may be specific to the Kth video clip. Therefore, after playing the Kth video clip, a sub-selection of response options that might logically follow the Kth video clip are displayed.

The available responses may be presented to the user as part of the Kth video clip (as part of step 310). In other embodiments, the response options may be stored and delivered to a user separate from the video clips. For example, some or all possible response options for all video clips may be stored in a database structure and referenced to relevant video clips. In this exemplary embodiment, a database links a particular video clip with all the responses that could potentially follow that video clip. Thus a sub-set of response options may exist for a Kth video clip. The sub-set of response options that can follow the Kth video clip may be reduced by eliminating redundant responses, i.e., responses previously selected by the user. In another example, the response options list may also be presented with an element of randomness, using the techniques described herein, to vary the available responses.

Receiving a User Response Selection:

User 150 next selects a desired response from the displayed list of available response options. The user may make the selection by clicking on a desired response, typing the response or an identifier thereof, scrolling to a response, speaking the response, or otherwise selecting one of the available options. The user response selection is received by the processor in a step 330. The response may be a statement to the subject, a command to the subject, a question to the subject, an action, and/or the like.

Selecting a Character Response:

The processor next selects a suitable subsequent video clip (step 340) as an appropriate response to the user's input received in step 330. For example, a list of possible subject response video clips is defined by the previous video clip and the user's response to the previous video clip. Each of the possible subject response video clips may be associated with a probability that that particular video clip will be selected from the list of possible video clips. Thus, a discrete probability distribution exists for the possible subject response video clips. “Life-like” user/subject interaction is facilitated through this probability distribution because the response selection is non-deterministic. In other words, a user may input the same response to the same video clip in two different sessions, where the sessions are identical up to this point in time, and yet the method may select different subsequent video clips in each session.

The video clip selection method may further facilitate “life-like” interaction by limiting repetition in the user/subject interaction, limiting non-sensical responses, and/or incorporating subject personality and interaction history into the selection process. This may be accomplished by adjusting the default probability distribution. The method may then repeat by returning to step 310 for display of the selected video clip.

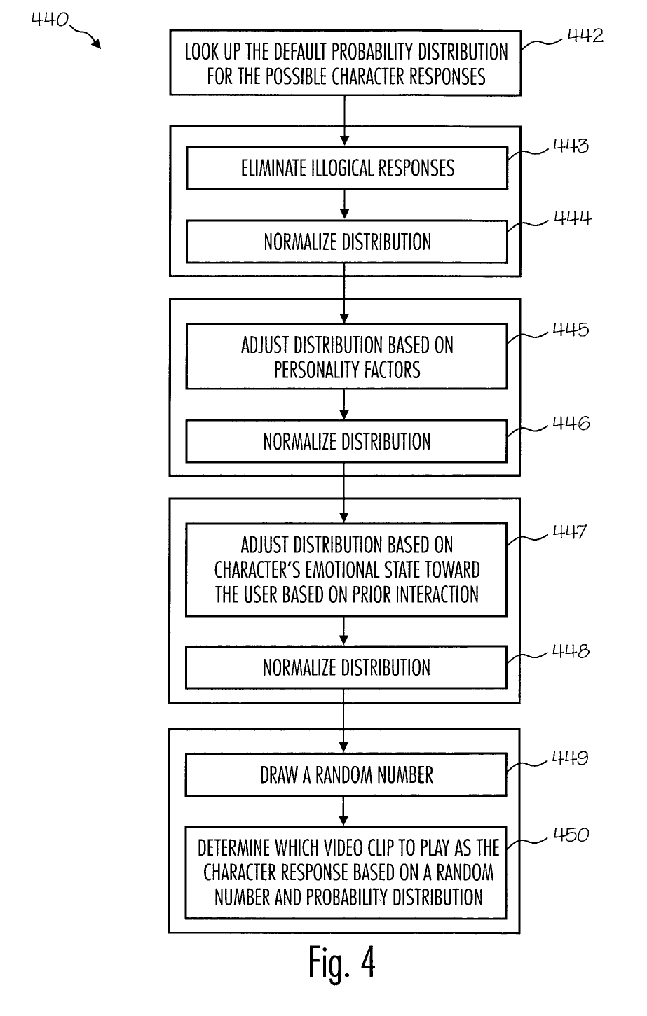

In an exemplary embodiment, video clips are selected for a suitable subject response using various steps and/or combinations of steps. FIG. 4 illustrates various video clip selection steps 440 that may be executed to select an appropriate subject response (response video clip) to the user's input. Such video clip selection steps include: looking up a default probability distribution for the possible video clips in step 442, eliminating illogical responses in steps 443 and 444, adjusting the probability distribution based on the character's personality factors in steps 445 and 446, adjusting the probability distribution based on prior interaction history in steps 447 and 448, and selecting a video clip to play, based on the probability distribution, in steps 449 and 450.

A default probability distribution for each combination of “last video clip” and “last user response” is stored in a suitable data structure. Based on the most recent actions of the user and the subject, a “get_prob_dist” function (See, computer program listing appendix.) first returns the discrete probability distribution of the possible character responses. For example, upon receiving a user response selection, a discrete default probability distribution for the possible subsequent video clips may be looked up from within a suitable data structure, in a step 442. In this example, the same default probability distribution results each time a particular video clip Ck is followed by a particular user response. However, this default probability distribution may be modified as described below.

The default probability distribution may be modified by eliminating illogical character responses in step 443. For example, if the filmed character has already identified himself as John Doe in a previous video clip, that particular video clip can be made unavailable for some future responses. Furthermore, in step 443 the repetitive use of a particular video clip or clips may be monitored and prevented. Thus, the video interaction method may include the ability to remove video clips from the list of possible video clip character responses based on prior interaction history. Nevertheless, step 443 may be configured to prevent the complete elimination of all video clip responses. In the event that the last possible video clip response might be eliminated, that video clip may be forced to remain, a default video clip may be selected, or some other provision may be made which sustains the flow of the interaction.

The video clip selection steps may further include the step 445 of adjusting the default probability distribution based on various personality factors of the subject. As described above, these personality factors may be set at default levels or may be modified and/or selected during an initial step in the video interaction method. The personality factors may be used to increase or decrease the probability of a particular video clip being selected. For example, if two available video clip character responses are positive/happy responses and two are negative/sad responses, the probability distribution may be adjusted in step 445 to increase the chances that a positive response is chosen for a character who has a personality factor with an above average optimism trait.

The video clip selection steps may further include the step 447 of adjusting the default probability distribution based on the character's emotional states and attitudes towards the user as a result of the prior interaction history. For example, the prior interaction between the user and the character may be monitored to obtain a sense of the “tone” of the conversation. The tone of the conversation may increase or decrease the probability of a particular video clip being selected. For example, if more civil exchanges have taken place than uncivil exchanges, the probability distribution may be adjusted to increase the probability of civil video clip responses from the character. Adjusting the probability distribution to account for the character's attitude towards the user may enhance the illusion, from the user's perspective, that the character can develop an emotional state towards the user. In another example, the use of profanity in the user's responses may result in an increased probability of stand-offish and/or negative video clip character responses.

Steps 443 and 447 may depend on the prior interaction history. The history may be kept in any suitable manner. For example, the user actions and character actions may be indexed in the order that the actions occur and may be stored with reference to an index number. In one example, the first video clip is stored as “character_action[0]” (as coded in computer program listing appendix) and the first user response to the first video clip is stored as “user_action[0]”. The index may be incremented and the actions recorded with each pass through steps 440. Thus configured, an appropriate function may determine if a particular user or character action has already taken place and/or how long ago the action took place. Other functions may examine the interaction history in order to search for various combinations or patterns, compute estimates that characterize the interaction, or obtain or compute various information.

The use of probability distributions suitably causes the video clip selection process to be a non-deterministic process, such that a given history of interaction does not always lead to the same subject response. Furthermore, the use of personality and prior interaction history to adjust the probability distributions, makes the non-deterministic character response appear to be more human or life-like.

In each case, after adjusting the probability distribution, or eliminating video clips from consideration, the probability distributions may no longer add up to 100%. Thus, in this exemplary embodiment of the present invention, the probability distributions may be normalized (Steps 444, 446, 448) to return the total probability among the remaining video clip choices to 100%. This may be accomplished, for example, by computing the sum of the probabilities in the distribution and dividing each probability by this sum. It is noted that various combinations of steps 443, 445, and 447 may be used and in various orders, as appropriate. For example, step 447 may adjust the default probability distribution directly if no other adjustments are made first, or step 447 may adjust the current probability distribution after one or more of steps 443 and 445 have made adjustments to the default probability distribution.

In adjusting probability distributions, a minimum probability may be set to keep the probability associated with a video clip from becoming practically insignificant. For example, the probability associated with any character response is prevented from being made less than 3% or 1% or another suitable percentage. A zero probability may not be realistic as humans are not generally so predictable. Furthermore, the method may be configured to avoid a 100% probability for any one video clip.

Once the probability distribution has been established, the video clip may be randomly selected based on the probability distribution. In a step 449, a random number is drawn. The random number is used in connection with the probability distribution to determine which video clip is to be played as the character response. This video clip is then played in step 310. Other video clip character response selection techniques can be used, such as artificial intelligence, etc.

### EXAMPLE

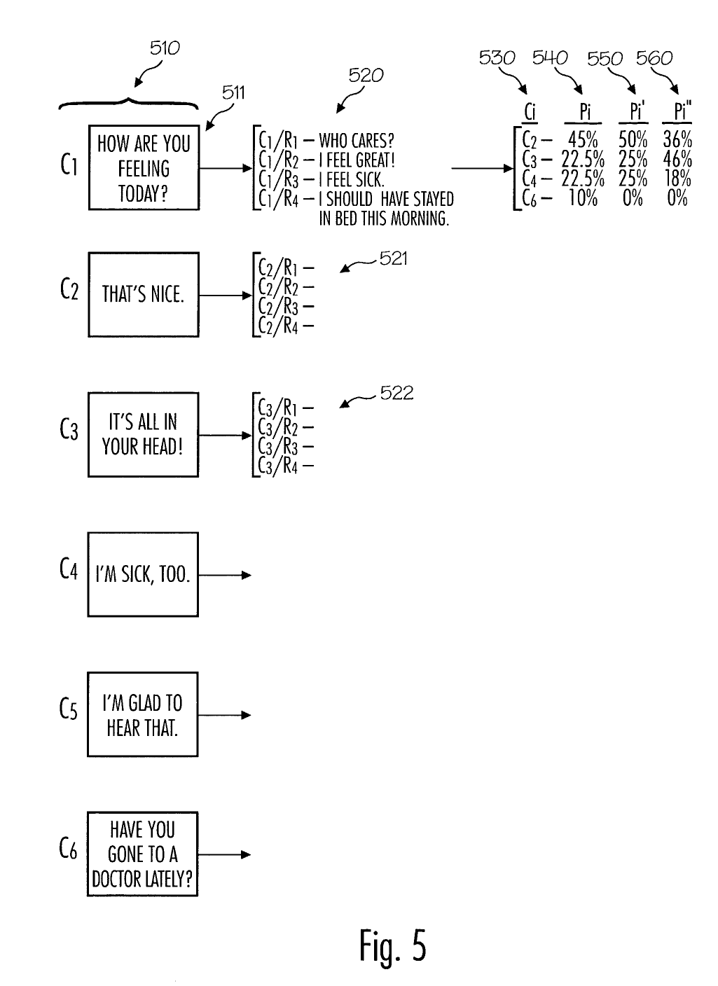

In one example, a character's personality has only two parameters that the user may adjust. These personality factors are F₁, for insensitivity, and F_{f} for friendliness. F₁ and F_{f} each are a number between 0 and 1. For example, 0 is the least possible insensitivity, 1 is the most possible insensitivity, and 0.5 is a normal or average insensitivity. A user may select Fₐ=0.8 and leave the friendliness factor at the default level F_{f}=0.5. For this example, reference is made to FIG. 5. In this example, video clips C₁ through C₁₀ 510 each are followed by four possible user responses, R₁ through R₄ (e.g., 520, 521, 522). For example, video clip C₁ 511 displays the subject who says, “How are you feeling today?” The user may select response R₃, to video clip C₁, that says, “I feel sick.” Four possible video clips 530 may provide workable responses to the C₁/R₃ combination, namely C₂, C₃, C₄ and C₆. Each of these four clips has a certain probability of being selected to be the character's response. These default probabilities 540 may be looked up, by the processor, from within a suitable data structure. If P₁is the probability of video clip C₁ being the actual character response, the default probabilities may be as follows: P₂ of 45%, P₃ of 22.5%, P₄ of 22.5% and P₆ of 10%.

For the purpose of this example, it is assumed that video clip C₆ was played earlier in the interaction. Therefore, the history of the interaction may be examined and video clip C₆ may be eliminated to reduce redundancy. P₆ is now 0% and the remaining probabilities only total 90%. The probability distribution is then normalized to create a modified probability distribution 550 where P₂′ is 50%, P₃′ is 25%, and P₄′ is 25%.

The probability distribution may be further adjusted to account for the personality of the subject such that, for example, the “friendlier” responses are made more/less likely depending on a high/low friendliness factor. The friendliness value is F_{f}=0.5 which is the default value and no adjustment is therefore made to the distribution. The insensitivity factor is above average at Fᵢ=0.8, thus an increase in the probability of video clip C₃, “It's all in your head!”, is expected relative to the probabilities of the other two clips. P₃ might be increased using a formula such as P₃=(2F₁)²*P₃, although other formulas may also be used. The adjusted distribution 560 is then: P₂32 50%, P₃=64%, and P₄=25%. This is normalized again to obtain: P₂″=36%, P₃″=46%, and P_{4b ″=18}%.

Additionally, the prior history of interaction may be examined to adjust the probability distribution further based on the character's emotional states or attitudes towards the user. An index may be used to determine how angry the character has become, or how positive the interaction has been. One or more indices serve as inputs into one or more formulas that modify the probability distribution of the next response. The distribution may again be normalized. To select the actual video clip to be played, a random number is drawn from the computer and used to select the actual video clip in light of the probability distribution.

State diagrams:

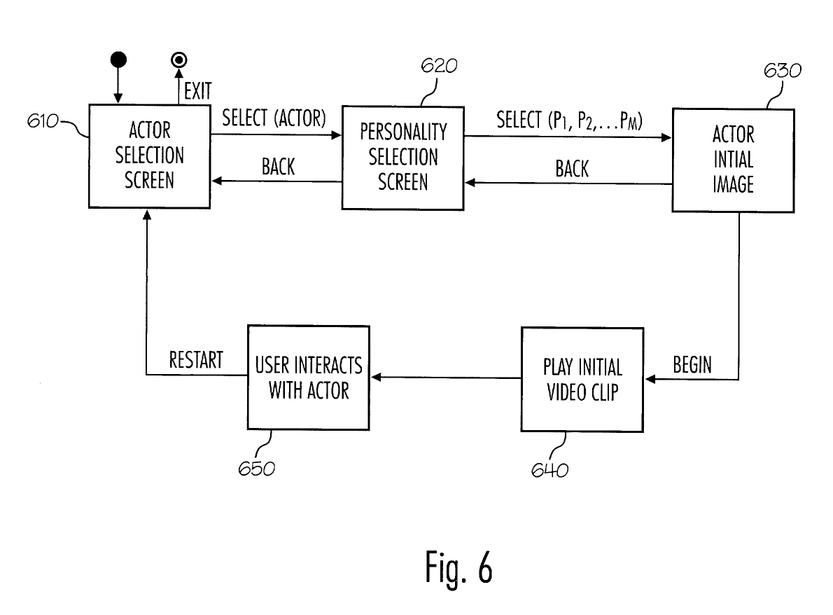

FIGS. 6, 7 and 8 illustrate exemplary state diagrams and activity diagrams of exemplary embodiments of the present invention. These diagrams conform to the Unified Modeling Language (UML), which is a commonly used standard for such diagrams. In the FIG. 6 example, states and activities include: actor selection screen state 610, personality selection screen 620, actor initial image state 630, play initial video clip activity 640, and user-character interaction state 650. A user may start a session at an actor selection screen state 610. Upon selection of an actor, select(actor), the user is presented a personality selection screen(s) at state 620. The personality selection screen(s) may show two or more personality parameters with default values set to reflect an average personality. In this state, the user may make adjustments to the personality of the actor. User selection of a suitable “Back” button returns to the actor selection state 610. After selecting one or more suitable personality factors, select(P₁, P₂, . . . Pₘ), pressing a button labeled “OK” advances the user to an initial image of the actor in state 630. The user may select a “back” button to return to the personality selection screen state 620 or select “begin” to play an initial video clip, activity 640. After the initial video clip plays, the session enters state 650 where the user interacts with the actor as described above in conjunction with FIG. 4. The user may press an appropriate button at any appropriate point in the user-character interactive state 650 to return to the actor selection screen, state 610.

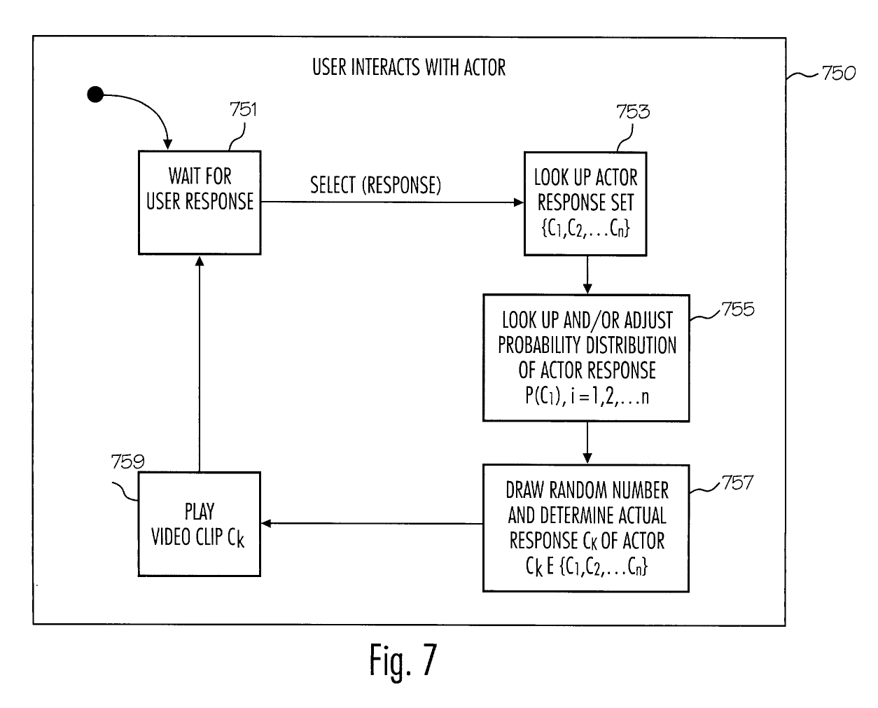

Interactive state 650 is further illustrated with reference now to FIG. 7. Upon entering interactive state 750, the system waits for a user response in state 751. The user is responding to a menu of response options that the user may make to the character. The user may select one of these responses. In some exemplary embodiments, an audio recording of the user's selection may be played back to the user.

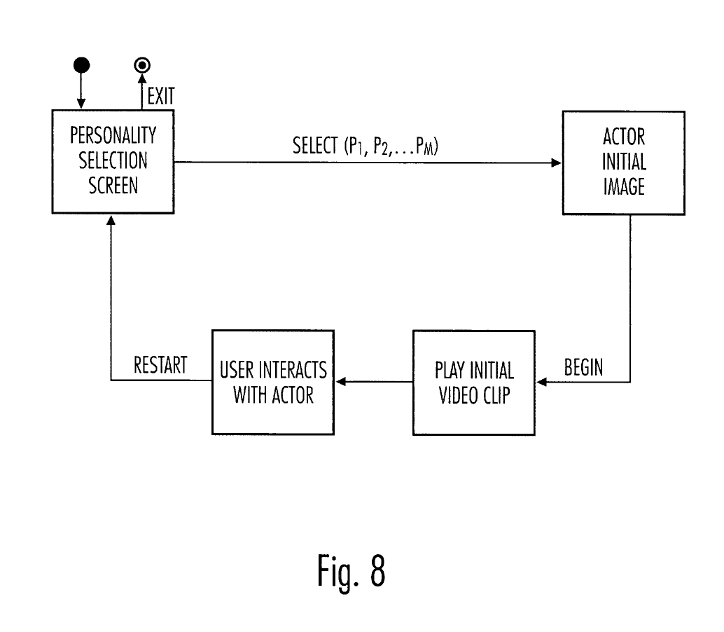

A user response, “select(response)”, prompts a change to activity 753 where an actor response set “{C₁, C₂, . . . Cₙ}” is looked up. C₁ represents the ith video clip in a set of n possible actor responses. In the next-activity, 755, a probability distribution associated with the actor response set is also looked up and/or determined. The probability associated with each of the video clips from the response set P(Cᵢ), i=1,2, . . . , n may be adjusted, thus adjusting the probability distribution. Then a random number is drawn in activity 757 and this random number is used in conjunction with the probability distribution to select the actual response Cₖ of the actor. Video clip Cₖ is played in activity 759. The system then returns to state 751 where it waits for a user response. It is noted that FIG. 8 is similar to FIG. 6 with the exception of removing the actor selection state and “back” options.

Termination:

The method may end naturally, or as requested by a user. For example, various sequences may lead to terminal video clips where the interaction ends. In one example, the subject may take offense to a user's response and a terminal video clip may indicate, “If that's how you feel about it, I'm leaving!” The subject may leave the scene, whereupon the programming returns the user to a starting screen for starting a new session. The interaction loop may include escape options allowing a user to temporarily suspend the interaction or to return to a starting screen and restart a new session. These escape options may be included at any suitable step in the video interaction loop.

Pseudo Code:

Although the system and method may be implemented using various code languages, such as C++, C#, Visual Basic, Java, or any other language using any number of programming modules or subroutines, an exemplary pseudo code, attached hereto as computer program listing appendix, illustrates the functionality and methodology of the present invention. The pseudo code is an exemplary embodiment of the present invention, and is not intended to limit the description of the invention. It is noted that the pseudo code, though written in Java language, is not intended for compilation and execution on a computer, but rather as an exemplary illustration of the methodology and functionality described herein. The pseudo code relates specifically to the embodiments described with reference to FIGS. 7 and 8 and generally to all the Figures.

In the pseudo-code, comments begin with “//”. Comments indicating where further code should be inserted begin with “///”. Code so designated is generally: a) GUI code that depends on which GUI development tool one uses, b) video manipulation code that depends on which tool one uses for video manipulation, c) repetitive pseudo code, and/or d) code that depends on the specifics of the entertainment application, rather than the method of the present invention. The pseudo-code is further described by line or section in Table 1, below. In the pseudo-code, data inputs from secondary storage are defined as follows:

“in.video-clips[i]” represents the video clip (including audio track) corresponding to index i;

“in.num_clips” represents the number of video clips;

“in.num_personality_params” represents the number of personality parameters;

“in.personality_param_names[k]” represents the name of the kth personality parameter;

“in.num_user_rsp[i]” represents the number of user responses possible after playing video clip i;

“in.user_rsp[i][j]” represents the text of the jth user response possible after playing video clip i; and

“in.char_rsp[i][j]” represents the default probability distribution of the character's response, given that the user chose the user response j to the presentation of video clip i. This probability distribution is a list of ordered tuples, where each tuple contains a video clip index and the default probability of selecting that video clip as the next response of the character.

Conclusion:

The present invention has been described above with reference to various exemplary embodiments. However, changes and modifications may be made to the exemplary embodiments without departing from the scope of the present invention. For example, the various components may be implemented in alternate ways. These alternatives can be suitably selected depending upon the particular application or in consideration of any number of factors associated with the operation of the video interaction. These changes or modifications are intended to be included within the scope of the present invention. The scope of the invention should be determined by the appended claims and their legal equivalents, rather than by the examples given above. The steps recited in any method claims may be practiced in the order recited, or in any other order. No elements or components described herein are necessary to the practice of the invention unless expressly described as “essential” or “required”.

Various aspects of the present invention may be described herein in terms of functional block components and various processing steps. It should be appreciated that such functional blocks may be realized by any number of hardware and/or software components configured to perform the specified functions. Furthermore, the connecting lines shown in the various figures contained herein are intended to represent exemplary functional relationships and/or physical couplings between the various elements. Many alternative or additional functional relationships or physical connections might be present in a practical interactive video system.

The particular implementations shown and described herein are illustrative of various exemplary embodiments of the invention and are not intended to limit the scope of the invention in any way. Indeed, for the sake of brevity, conventional computer system architecture, application development and other functional aspects of the systems (and components of the individual operating components of the systems) may not be described in detail herein. For example, the software elements described herein may be implemented with any programming or scripting language such as C, C++, PASCAL, Objective C, Ada, Java, Swing graphics for Java, Visual C++ for Windows, assembler, PERL, PHP, any database programming language, any Graphical User Interface (GUI), or the like. Similarly, the software and algorithms executed by the various processing components may be implemented with any combination of data structures, files, objects, processes, routines or other programming elements.

TABLE 1

| Line | |
|---|---|
| Number | Comments |
| 1.1.0 | The main ( ) function of class Main is the sole entry point to the system. |
| 1.1.9 | The InputData object encapsulates all data on secondary storage. This |
| | data is not modified during execution. |
| 1.1.11-1.1.12 | Define the first video clip to play during each sequence of interaction. In |
| | this code the choice of clip 2 is arbitrary. In another example a random |
| | selection is made from suitable candidates to be the first clip. |
| 1.1.13 | The Personality object contains the character's personality. This class |
| | is defined at line 6.0.0. |
| 1.1.20 | The loop from line 1.1.20 to line 1.1.26 corresponds to the loop in the state |
| | chart diagram of FIG. 8. In each pass through the loop, the personality |
| | screen is displayed, allowing the user to adjust the character's personality, |
| | and then execute a new sequence of interaction between the user and |
| | character. |
| 1.1.22-1.1.23 | The image of the character is displayed at the beginning of the first video |
| | clip, wait for the user to begin, and then play the first video clip. |
| 1.1.24-1.1.25 | Execute a new sequence of interaction between the user and character. The |
| | Interaction class begins at line 3.0.2. |
| 2.0.2-2.0.5 | The History class maintains the history of a sequence of interaction |
| | between the user and character. Char_actions contains the integer ID |
| | numbers of video clips, in the order in which the clips have been played |
| | during the interaction. User_actions contains the integer ID numbers |
| | of the user responses, also in chronological order. Each element in |
| | char_actions matches that at the same index in user_actions. For |
| | example, if K is the integer in the sixth position of char_actions and J is the |
| | integer in the sixth position of user_actions, then the user said dialog line J |
| | in response to video clip K, in the sixth cycle during the interaction. |
| 2.2.0 | This function adds a character action (an integer that identifies the video |
| | clip) at the end of the history. |
| 2.3.0 | This function adds a user action at the end of the history. |
| 2.4.0-2.4.10 | The find_char_action ( ) function returns true if the given character |
| | action is present in the history. Otherwise, the function returns false. This |
| | linear search offers adequate performance, as the history is not large. |
| 2.5.0 | As indicated by the comment at lines 2.5.2 and 2.5.3, the function |
| | find_user_action_as_response ( ) returns true if the given user |
| | action has occurred in response to the given character action. This function |
| | is not called by any code appearing explicitly in the computer program |
| | listing appendix. But the function could be called by any code section |
| | developed within any of the functions from line 3.4.0 to line 3.10.5. |
| 3.0.2 | The Interaction class encapsulates the repeating cycle in which the user |
| | interacts with the character. The only public members of this class are the |
| | run ( ) function (3.1.0) and the constructor (3.14.0). |
| 3.0.4-3.0.7 | These objects are passed into the Interaction constructor defined at line |
| | 3.14.0. |
| 3.1.0 | An entire sequence of interaction occurs in the run ( ) function. |
| 3.1.9-3.1.10 | After executing line 3.1.10, the History object associated with this |
| | Interaction contains the only action to have occurred so far, which is the |
| | playing of the initial video clip at line 1.1.23. |
| 3.1.13-3.1.14 | The user selects a set of dialog line options presented to the user. At line |
| | 3.1.22, the user will choose one of these lines as his response to the |
| | presentation of the initial video clip. |
| 3.1.18 | This while loop corresponds to the loop appearing in FIG. 7. In each pass |
| | through the loop, the user acts in response to the character, and then the |
| | character acts in response to the user. Execution blocks at line 3.1.22 until |
| | the user acts. The user action is either a dialog line in response to the |
| | character or a request to terminate the interaction. In the later case, exit the |
| | loop at line 3.1.23. |
| 3.1.27 | The function get_prob_dist ( ) returns the discrete probability |
| | distribution of the possible character responses. Each possible response is a |
| | video clip identified by an integer index. The probability distribution |
| | depends on the most recent actions of the user and character, which are the |
| | arguments to get_prob_dist ( ). The distribution may also depend on |
| | the history of the interaction and the character's personality and emotional |
| | state. |
| 3.1.28 | Here the user action that occurred at line 3.1.22 is put into the History |
| | object. This occurs after the call to get_prob_dist ( ) in order to avoid |
| | any chance of having an unintended effect on get_prob_dist ( ). |
| 3.1.29-3.1.33 | Determine the character action based on its probability distribution, play the |
| | video clip with a leading transition effect, and add the character action to the |
| | history of interaction. |
| 3.1.37-3.1.38 | The set of responses allowed to the user depends only on which video clip |
| | just played. This video clip is identified by the index stored in the variable |
| | char_rsp. |
| 3.2.0-3.2.8 | In the computer program listing appendix, all comments that begin with “///” |
| | describe code to be inserted. The functionality in |
| | wait_for_user_response ( ) is implemented in a way that depends |
| | on the GUI tool used to implement the GUI of the entire application. The |
| | arguments to wait_for_user_response ( ) specify the set of dialog |
| | lines from which the user is to select his response. The GUI displays these |
| | lines to the user. Different embodiments of the invention allow different |
| | methods for the user to make his selection. Some possible methods include: |
| | 1) speaking the response , or 2) using the computer mouse to select among |
| | boxes containing the responses. If selection is made using the mouse, then |
| | the computer might play a voice recording of the selection. |
| 3.3.0 | The function get_prob_dist ( ) returns the discrete probability |
| | distribution of the possible character responses. Each possible response is a |
| | video clip identified by an integer index. The probability distribution |
| | depends on last_user_act and last_char_act, which are the |
| | most recent actions of the user and character. The distribution may also |
| | depend on the history of the interaction and the character's personality and |
| | emotional state. |
| 3.3.2-3.3.3 | In the computer program listing appendix, a probability distribution of the |
| | character's response is represented by an ArrayList. Each element in the |
| | ArrayList is a ClipProb object. The ClipProb class, defined at line 7.0.0, |
| | stores the ID of a character response and the probability of that response. |
| | The order of ClipProb objects in the ArrayList has no significance. |
| 3.3.5 | The default probability distribution is determined by the last video clip |
| | played and the user's response to that clip. These distributions were read |
| | from secondary storage by the InputData constructor. |
| 3.3.7-3.3.51 | The case selection structure extending from line 3.3.7 to line 3.3.51 decides |
| | which routine to call in order to adjust the default distribution to obtain the |
| | distribution used in determining the character's response. The routine to |
| | call depends on the last video clip played (last_char_act) and the user |
| | response to that clip (last_user_act). These routines have a naming |
| | convention. See the comments pertaining to lines 3.5.0 through 3.10.5. |
| | This set of routines assumes that the system includes only three video clips |
| | and two or three possible user responses to each clip. In an actual |
| | implementation of the invention, dozens or hundreds of video clips may |
| | exist as well as multiple user responses per clip, many more routines to |
| | compute probability distributions, and a larger block of code to select which |
| | routine to call. |
| 3.4.0 | The routine get_prob_dist_1_1 ( ) returns the probability distribution |
| | of the character's action for the case where the previous character action |
| | was video clip #1 and the user choose the first response in the list of |
| | available to responses to this clip. The code in get_prob_dist_1_1 ( ) |
| | provides an example for how to write all the routines with names of the |
| | form get_prob_dist_N_M ( ), where N and M are positive integers. |
| | The overall structure of all these routines is the same. First, any character |
| | actions that would not make sense given the history of interaction are |
| | removed from the probability distribution (lines 3.4.10 through 3.4.17). |
| | Then normalize ( ) is called at line 3.4.18. Then modify the distribution |
| | to account for the character's personality (lines 3.4.25 through 3.4.34). |
| | Then call normalize ( ) at line 3.4.35. Finally, if this embodiment tracks |
| | emotions of the subject, modify the distribution to account for the |
| | character's emotional state and attitude towards the user given the past |
| | interaction history, line 3.4.37. |
| 3.4.10-3.4.17 | Remove from the probability distribution any character actions that would |
| | not make sense given the history of interaction. The code between lines |
| | 3.4.10 and 3.4.17 is an example of such a removal. This code merely |
| | eliminates clip 3 from the distribution if clip 3 was already played at any |
| | time during the history of interaction. Suppose the character's dialog line in |
| | clip 3 was “My name is Mary. ”The character should not repeat this line. It |
| | may be desirable that to guarantee that other lines are not repeated. |
| | Furthermore, a character action may be eliminated if the user has already |
| | given a specific response to a specific character action. For example, if at |
| | any time the character said “What is your favorite color?” and the user |
| | responded “red”, then the character should not now ask “Do you like the |
| | color red?”. In order to determine if the user has given a specific response |
| | to a specific character action, call the History function |
| | find_user_action_as_response ( ). In order to perform other |
| | types of searches of the History, additional History class functions may be |
| | written. |
| 3.4.18 | Removal of any character actions from the probability distribution may |
| | cause the probabilities in the distribution add up to a number less than one. |
| | Call normalize ( ) to rescale the probabilities so that they add up to one. |
| 3.4.25-3.4.34 | The default probability distribution assumes that each of the character's |
| | personality parameters have the default value of 0.5 on a scale from 0 to 1. |
| | If any of the personality parameters differ from 0.5, the probability |
| | distribution may be modified to account for the character's personality. |
| | There are many types of logic that may be appropriate to perform this |
| | modification. The code from line 3.4.25 to line 3.4.34 shows a specific |
| | logic described by the comments from lines 3.4.20 through 3.4.23. In line |
| | 3.4.30, person.get_param_value (5) is the value of personality |
| | parameter number 5. Notice that the statement on this line does not modify |
| | the probability if the personality parameter has the value 0.5. Whatever |
| | logic is used to modify the distribution, it should prevent any probabilities |
| | from decreasing below roughly 1% to 3%. |
| 3.4.35 | If the probability distribution was modified to account for personality, then |
| | the probabilities in the distribution may no longer add up to one. Call |
| | normalize ( ) to rescale the probabilities so that they add up to one. |
| 3.4.37-3.4.38 | If this embodiment of the invention is tracking the emotions of the character, |
| | then this is an appropriate point in the code to modify the probability |
| | distribution to account for the emotions. The emotion variables are |
| | modified by inserting code at line 3.1.24 and possibly at 3.1.34. |
| 3.5.0-3.10.5 | These routines and get_prob_dist_1_1 ( ) are called from within the |
| | case selection structure that extends from line 3.3.7 to 3.3.51. Each of these |
| | routines takes a default probability distribution of character response as the |
| | input parameter. Each routine computes and returns the probability |
| | distribution that will be used in the determination of the character's |
| | response. The names of the routines have the form |
| | get_prob_dist_N_M ( ), where N and M are the indices of the most |
| | recent actions of the character and user, respectively. The code to insert in |
| | these routines depends on the specific entertainment application. For |
| | guidance on how to write this code, see the above comments pertaining to |
| | lines 3.4.0 through 3.4.41. This set of routines assumes that the system |
| | includes only three video clips and two or three possible user responses to |
| | each clip. In an actual implementation of the invention, dozens or hundreds |
| | of video clips may exist as well as multiple user responses per clip. Thus, |
| | hundreds of routines may be used with names of the form |
| | get_prob_dist_N_M ( ). |
| 3.11.0 | The argument to the normalize ( ) function is a probability distribution |
| | of character response. If the probabilities in the distribution do not add up to |
| | one, then normalize ( ) will scale them to add up to one. |
| 3.11.9-3.11.13 | Compute the sum of the probabilities in the distribution. |
| 3.11.17-3.11.22 | Divide each probability by the previously computed sum. |
| 3.12.0 | The function random_draw ( ) is called from line 3.13.5. |
| 3.13.0 | The select_char_response ( ) function draws a random number to |
| | determine the character's response to the user, based on the probability |
| | distribution of the response. The return value is the index to the video clip |
| | containing the character's response. |
| 4.0.1-4.1.4 | The InputData class encapsulates all the data on secondary storage. This |
| | data cannot be modified by the execution of the application. |
| 5.0.0 | The Player class decodes, plays and performs other manipulations on video |
| | and audio media stored in a compressed format such as MPEG. The |
| | implementation of this class depends on which toolset or package one uses. |
| 5.2.0 | In a possible implementation, the video clip may be on disk, not in memory, |
| | at the time the play ( ) function is called. This implementation may have |
| | too large of a start-up latency, that is, too much delay between the time the |
| | user acts and the time when the character response begins to play on the |
| | screen at high resolution. In order to reduce this delay, prefetch (load into |
| | memory) video clips or their beginning portions before the time when the |
| | clip needs to be played. Prefetch operations may require extra threads of |
| | execution. An opportunity for prefetching may exist when the system is |
| | waiting for the user to respond to the last video clip playback. However, the |
| | next video clip to play is not fully determined. There would normally be |
| | more than ten clips possible as the next character action. Issues of start-up |
| | latency and prefetching are hardware dependent. |
| 5.3.0 | The show_first_frame ( ) function is called from line 1.1.22, just |
| | before beginning the interaction between character and user. |
| 5.4.0 | The transition ( ) function performs a transition between video clips. |
| | After a clip is played, the final frame stays on the screen while the user |
| | decides how to respond. When the next video clip starts to play, the |
| | character is not exactly in the same position. The difference in position may |
| | be very minor in some cases. In other cases, while performing in the prior |
| | clip, the actor may have moved from a standard starting position in the |
| | scene. Some type of simple transition is necessary. For example, a bar may |
| | move across the video area, replacing the final image of the previous clip |
| | with the first image of the new clip. The new image stays on the screen for |
| | a brief moment before the new clip starts to play. |
| 6.0.0 | The Personality class maintains the character's personality data. |
| 6.0.2-6.0.3 | Each number in the param_val array is the amount of a specific |
| | personality trait possessed by the character. Each of these amounts can vary |
| | from zero to one. The default is 0.5. |
| 6.2.0-6.2.6 | The personality screen will have controls that allow the user to set the values |
| | of any or all personality parameters. Each parameter will have a control |
| | method such as a slider or a set of radio buttons or some other method. The |
| | screen also has an “OK” button and a button or method of stopping the |
| | program and closing the application. The implementation of this screen |
| | depends on the GUI development tool used. |
| 6.3.0 | The function get_param_value ( ) returns the value of the personality |
| | parameter given by the argument param_id. |
| 7.0.0 | Each probability distribution of the character's response is stored in an |
| | ArrayList. The elements in the ArrayList are ClipProb objects. |

What is claimed is:

1. A method of allowing a user to interact with a computer based subject, the method comprising the steps of:
presenting the user with at least one option for interacting with the subject;
receiving a user selection representing one of said at least one option;
selecting one of a plurality of pre-recorded video clips of the subject based at least in part on the user selection, wherein said plurality of video clips comprise a filmed subject; and,
displaying said selected video clip to the user.

2. The method of claim 1 wherein said video clip is selected non-deterministically.

3. The method of claim 2 wherein said video clip is selected based on a probability distribution associated with the user selected option for each of said plurality of pre-recorded video clips.

4. The method of claim 3 wherein said selecting of said video clip is based at least in part on the previous interactions between the user and the computer based subject.

5. The method of claim 4 wherein said selecting of said video clip is based at least in part on the subject's emotions and attitude toward the user, wherein said emotions and attitude are determined based on the previous interactions between said user and the computer based subject.

6. The method of claim 3 further comprising the steps of:
receiving from the user a personality parameter selection representing a personality characteristic of the subject; and
modifying said probability distribution associated with each option based on said personality parameter selection.

7. The method of claim 3 further comprising the steps of:
receiving from the user a personality parameter selection representing a personality characteristic of the subject; and
modifying said probability distribution associated with each option based on said personality parameter selection, and wherein said selecting of said video clip is based at least in part on the previous interactions between the user and the computer based subject.

8. The method of claim 4 further comprising the step of receiving a user subject selection.

9. The method of claim 8 further comprising the step of displaying an initial video clip of the subject before interaction begins.

10. The method of claim 1 wherein the subject is a human.

11. The method of claim 1 wherein the subject is in presence of no other subject.

12. The method of claim 1 wherein said displaying step includes both a visual and an audio display of said video clip.

13. The method of claim 1 further comprising the step of receiving from the user a personality parameter selection representing a personality characteristic of the subject, and wherein said selecting of one of a plurality of pre-recorded video clips is partly based on said personality parameter selection.

14. The method of claim 1 wherein said receiving a user selection step includes receiving a signal from a keyboard identifying one of said at least one option.

15. The method of claim 1 wherein said receiving a user selection step includes receiving a signal from a mouse identifying one of said at least one option.

16. The method of claim 1 wherein said receiving a user selection step includes receiving a signal from a remote control device identifying one of said at least one option.

17. The method of claim 1 wherein said receiving a user selection step includes receiving a signal from a voice recognition device identifying one of said at least one option.

18. A computer system facilitating interactions between a user and a computer based subject, the system being configured to execute the steps of:
presenting the user with at least one option for interacting with the subject;
receiving a user selection representing one of said at least one option;
selecting one of a plurality of pre-recorded video clips of the subject based at least in part on the user selection, wherein said plurality of video clips comprise a filmed subject; and,
displaying said selected video clip to the user.

19. The computer system of claim 18 wherein said video clip is selected non-deterministically based on a probability distribution associated with the user selected option for each of said plurality of pre-recorded video clips.

20. The computer system of claim 19 wherein said selecting of said video clip is based at least in part on the previous interactions between the user and the computer based subject.

21. The computer system of claim 20 wherein said selecting of said video clip is based at least in part on the subject's emotions and attitude toward the user, wherein said emotions and attitude are determined based on the previous interactions between said user and the computer based subject.

22. The method of claim 21 further comprising the steps of:
receiving from the user a personality parameter selection representing a personality characteristic of the subject; and
modifying said probability distribution associated with each option based on said personality parameter selection.

23. The method of claim 18 further comprising the step of receiving a user subject selection.

24. The method of claim 18 wherein the subject is a human.

25. The method of claim 18 wherein the subject is in presence of no other subject.

26. The method of claim 18 further comprising the step of receiving from the user a personality parameter selection representing a personality characteristic of the subject, and wherein said selecting of one of a plurality of pre-recorded video clips is partly based on said personality parameter selection.

27. A system for interacting with a subject, the system comprising:
an input/output module configured to receive a user selection representing one of at least one available user response; and
a processing module configured to select one of a plurality of video clips of the subject, wherein said selection of said video clip is performed non-deterministically and is based on a prior history of interaction between said user and the subject including said user selection, and wherein said plurality of video clips comprise a filmed subject; and,
a display module configured to display said selected video clip.

28. The system of claim 27 wherein said non-deterministic selection is based on a probability distribution associated with the user response for each of said plurality of pre-recorded video clips.

29. The system of claim 27 further comprising:
a subject selection module configured to receive a user selection representing one of at least two available subjects.

30. The system of claim 29 further comprising:
a personality selection module configured to receive a user personality parameter representing a personality characteristic of the subject.

31. The system of claim 30 wherein the processing module is further configured to select one of said plurality of video clips of the subject based at least in part on said personality parameter.

32. A computer-readable medium having computer-executable instructions stored thereon for controlling a computer to provide an interactive video experience with a single subject, wherein the instructions comprise:
a first software component configured to receive a personality selection from said user computer input device;
a second software component configured to display a selected video clip of a subject;
a third software component configured receive a user selection representing one of at least one option for interacting with the subject; and
a fourth software component configured to select one of a plurality of pre-recorded video clips of the subject based at least in part on the user selection, the subject personality selection, and the history of interaction between the subject and the user.

33. The computer-readable medium of claim 32 further comprising a fifth software component configured to receive a selection of said subject from a user computer input device.

34. A system for providing a user with an interactive video session with a single subject, the system comprising:
an input device, wherein the input device comprises:
means for providing a user selection of response options to the system;
a processor, wherein the processor comprises:
means for receiving said user selection of response options;
means for recording a portion of the prior interaction history between the user and the subject;
means for generating a video clip selection, wherein said video clip selection is based at least in part on said user selection of response options, and said prior interaction history; and
an output device, wherein said output device comprises:
means for displaying said selected video clip of said subject.

35. The system of claim 34 wherein said input device further comprises:
means for providing a subject selection from a user to the system; and
means for providing a personality selection from a user to the system.

36. The system of claim 35 wherein said processor further comprises:
means for receiving said subject selection;
means for receiving said personality selection; and wherein said video clip selection is further based at least in part on said personality selection.

37. A method of interacting with a video subject, the method comprising the steps of:
inputting a subject selection into a user interface to a user computer;
inputting a personality selection into a user interface to a user computer;
observing a video clip cued by said user computer, wherein said video clip comprises a single subject that has been filmed, wherein said video clip is non-deterministically selected based on a probability distribution, and wherein said video clip is selected based at least in part on said personality selection; and
inputting a user response selection to said observed video clip, wherein said video clip selection is further based on said user response selection.
